(19) United States
(12) Patent Application Publication
(10) Pub. No.: US 2021/0395982 A1
(43) Pub. Date: Dec. 23, 2021

(54) SYSTEM AND METHOD FOR WORK MACHINE

(71) Applicant: KOMATSU LTD., Tokyo (JP)

(72) Inventors: Koichi NAKAZAWA, Tokyo (JP); Osamu YATSUDA, Tokyo (JP)

(21) Appl. No.: 17/289,759

(22) PCT Filed: Jan. 20, 2020
(86) PCT No.: PCT/JP2020/001774

§ 371 Date: Apr. 29, 2021

(30) Foreign Application Priority Data
Jan. 23, 2019 (JP) 2019-008902

(51) Int. Cl. E02F 9/26; G01S 7/51; G01S 17/89; G01S 17/931; G01S 17/08

(52) U.S. Cl. CPC E02F 9/265; E02F 9/262; G01S 17/08; G01S 17/89; G01S 17/931; G01S 7/51

(57) ABSTRACT

A system includes a processor and a display. A LiDAR is attached to a work machine and includes a laser and a photodetector. The LiDAR measures a distance to at least a part of a work implement and a distance to an object around the work machine. The processor acquires position data from the distances measured by the LiDAR. The position data indicates a position of at least the part of the work implement and a position of the object around the work machine. The processor generates an image indicative of the position of at least the part of the work implement and the object around the work machine based on the position data. The display displays an image in response to a signal from the processor. The system may further include the work machine and the LiDAR.

### CROSS-REFERENCE TO RELATED APPLICATIONS

This application is a U.S. National stage application of International Application No. PCT/JP2020/001774, filed on Jan. 20, 2020. This U.S. National stage application claims priority under 35 U.S.C. § 119(a) to Japanese Patent Application No. 2019-008902, filed in Japan on Jan. 23, 2019, the entire contents of which are hereby incorporated herein by reference.

### BACKGROUND

### Field of the Invention

The present disclosure relates to a system and a method for a work machine.

### Background Information

Conventionally, a technique for displaying an image of a work machine captured by a camera on a display is known. For example, as illustrated in US Patent Publication No. 2014/0240506, an on-vehicle camera mounted on the work machine captures an image of the work machine and its field of view in the front, rear, left or right direction, and the image is displayed on the display. Further, in US Patent Publication No. 2014/0240506, there is provided a site camera that automatically moves to follow the work machine as the work machine moves. The sight camera is disposed away from the work machine to capture a wider field of view at a work site.

### SUMMARY

In the above-mentioned technique, the image captured by the on-vehicle camera is displayed on the display as it is. In this case, depending on a topography such as the one with large undulations, it may be difficult to accurately recognize a positional relationship between the work machine and the topography from the image displayed on the display.

In the above-mentioned technique, a wider field of view at the work site can be captured using the site camera. However, in that case, it is necessary to control the site camera with high accuracy. This makes the system complicated or increases the cost of the system.

An object of the present disclosure is to provide a system and a method capable of easily and accurately recognizing a positional relationship between a work machine and an object around the work machine.

A system according to a first aspect is a system including a work machine, a light detection and a LiDAR, a processor, and a display. The work machine includes a work implement. The LiDAR is attached to the work machine and includes a laser and a photodetector. The LiDAR measures a distance to at least a part of the work implement and a distance to an object around the work machine. The processor acquires position data from the distances measured by the LiDAR. The position data indicates a position of at least the part of the work implement and a position of the object around the work machine. The processor generates an image indicative of the position of at least the part of the work implement and the position of the object around the work machine based on the position data. The display displays the image in response to a signal from the processor.

A method according to a second aspect is a method executed by a processor in order to display a topography around a work machine including a work implement and a position of the work implement on a display. The method includes the following processes. A first process is to measure a distance to at least a part of the work implement and a distance to an object around the work machine by a LiDAR. A second process is to acquire position data from the distances measured by the LiDAR. The position data indicates a position of at least the part of the work implement and a position of the object around the work machine. A third process is to generate an image indicative of the position of at least the part of the work implement and the position of the object around the work machine based on the position data. A fourth process is to display the image on the display.

A system according to a third aspect is a system including a processor and a display. The processor acquires a distance to at least a part of a work implement and a distance to an object around a work machine measured by a LiDAR. The processor acquires position data from the distances measured by the LiDAR. The position data indicates a position of at least the part of the work implement and a position of the object around the work machine. The processor generates an image indicative of the position of at least the part of the work implement and the position of the object around the work machine based on the position data. The display displays the image in response to a signal from the processor.

In the present disclosure, the position data is acquired from the distances measured by the LiDAR. Then, the image is generated based on the position data and displayed on the display. The image indicates the position of at least the part of the work implement and the object around the work machine. Therefore, the positional relationship between the work machine and the object around the work machine can be easily and accurately recognized.

### BRIEF DESCRIPTION OF DRAWINGS

FIG. 1 is a side view of a work machine according to an embodiment.

FIG. 2 is a block diagram of a configuration of a system according to the embodiment.

FIG. 3 is an enlarged side view of the work machine and a LiDAR.

FIG. 4 is an enlarged front view of the work machine and the LiDAR.

FIG. 5 is a schematic view illustrating a configuration of the LiDAR.

FIG. 6 is a flowchart illustrating processes executed by a controller.

FIG. 7 is a view illustrating an example of an image.

FIG. 8 is a block diagram illustrating a configuration of the system according to a modified example.

### DETAILED DESCRIPTION OF EMBODIMENT(S)

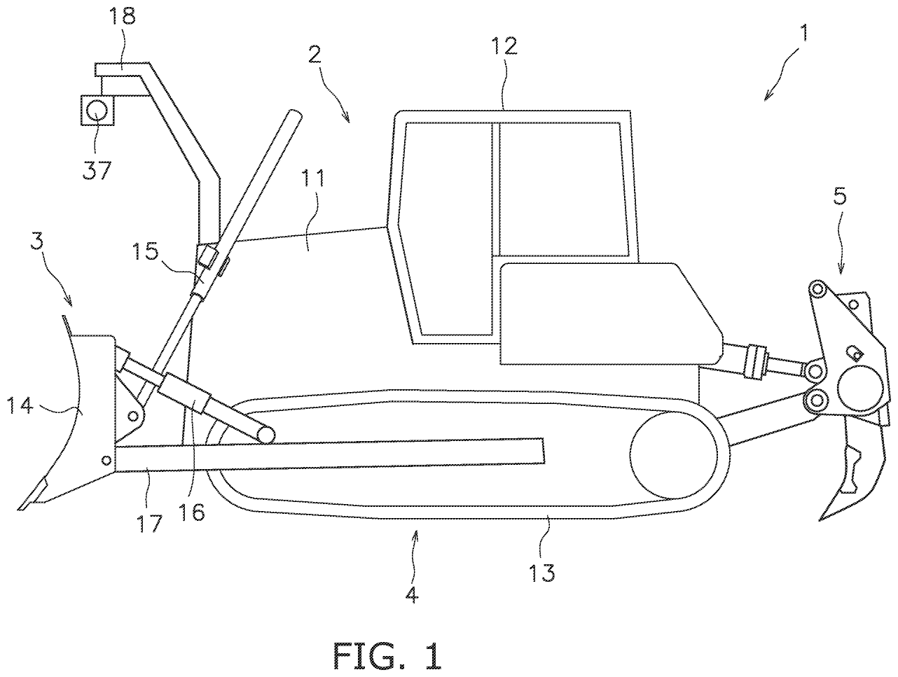

A system for a work machine according to an embodiment will now be described with reference to the drawings. FIG. 1 is a side view of a work machine 1 according to the embodiment. In this embodiment, the work machine 1 is a bulldozer. The work machine 1 includes a vehicle body 2, a work implement 3, and a travel device 4.

The vehicle body 2 includes an engine compartment 11. An operating cabin 12 is disposed at the rear of the engine compartment 11. A ripper device 5 is attached to a rear part of the vehicle body 2. The travel device 4 is a device for causing the work machine 1 to travel. The travel device 4 includes a pair of crawler belts 13 disposed on the left and right sides of the vehicle body 2. The work machine 1 travels due to the crawler belts 13 being driven.

The work implement 3 is disposed in front of the vehicle body 2. The work implement 3 is used for work such as digging, earthmoving, ground leveling, or the like. The work implement 3 includes a blade 14, a lift cylinder 15, a tilt cylinder 16, and an arm 17. The blade 14 is supported on the vehicle body 2 via the arm 17. The blade 14 is configured to be move in the up-down direction. The tilt cylinder 16 and the lift cylinder 15 are driven by hydraulic fluid discharged from a hydraulic pump 22 described later and change the posture of the blade 14.

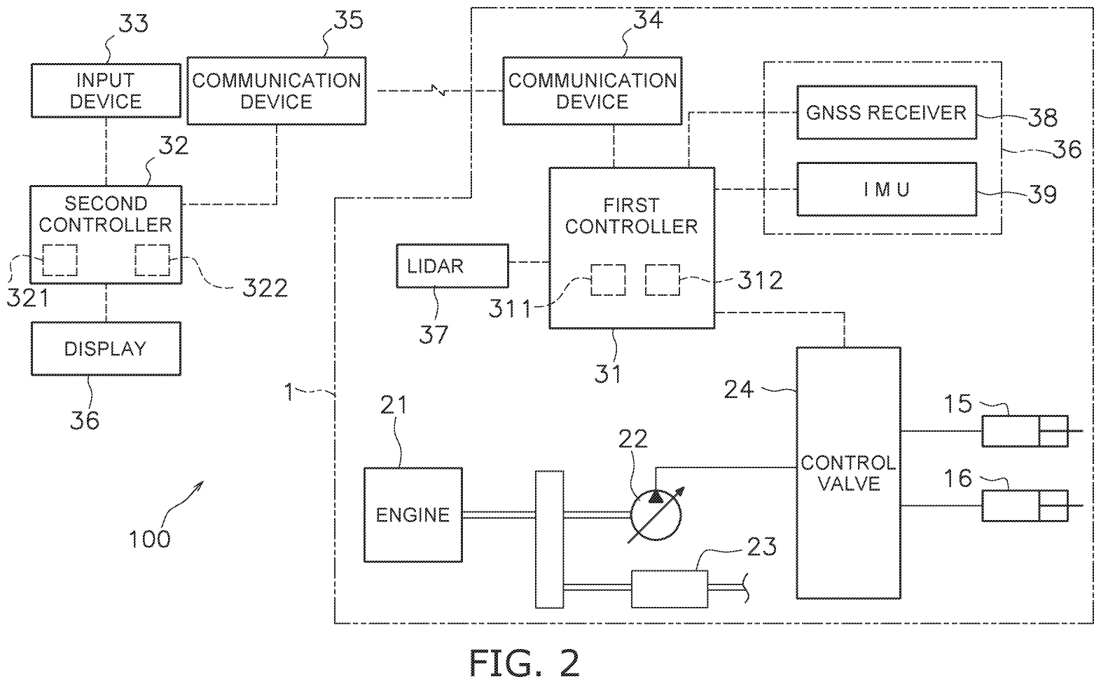

FIG. 2 is a block diagram of a configuration of a system 100 according to the embodiment. As illustrated in FIG. 2, the work machine 1 includes an engine 21, the hydraulic pump 22, a power transmission device 23, and a control valve 24. The engine 21, the hydraulic pump 22, and the power transmission device 23 are disposed in the engine compartment 11. The hydraulic pump 22 is driven by the engine 21 to discharge hydraulic fluid. The hydraulic fluid discharged from the hydraulic pump 22 is supplied to the lift cylinder 15 and the tilt cylinder 16. Although one hydraulic pump 22 is illustrated in FIG. 2, a plurality of hydraulic pumps may be provided.

The power transmission device 23 transmits driving force of the engine 21 to the travel device 4. The power transmission device 23 may be a hydro static transmission (HST), for example. Alternatively, the power transmission device 23 may be, for example, a torque converter or a transmission having a plurality of transmission gears.

The control valve 24 is a proportional control valve and is controlled according to an input command signal. The control valve 24 is disposed between the hydraulic pump 22 and hydraulic actuators such as the lift cylinder 15 and the tilt cylinder 16. The control valve 24 controls the flow rate of the hydraulic fluid supplied from the hydraulic pump 22 to the lift cylinder 15 and the tilt cylinder 16. The control valve 24 may be a pressure proportional control valve. Alternatively, the control valve 24 may be an electromagnetic proportional control valve.

The system 100 includes a first controller 31, a second controller 32, an input device 33, communication devices 34 and 35, and a display 36. The first controller 31 and the communication device 34 are mounted on the work machine 1. The second controller 32, the input device 33, the communication devices 34 and 35, and the display 36 are disposed outside of the work machine 1. For example, the second controller 32, the input device 33, the communication device 35, and the display 36 are disposed in a control center away from a work site. The work machine 1 can be operated remotely using the input device 33 outside of the work machine 1.

The first controller 31 and the second controller 32 are programmed to control the work machine 1. The first controller 31 includes a memory 311 and a processor 312. The memory 311 includes, for example, a volatile memory such as a RAM and a non-volatile memory such as a ROM. The memory 311 stores programs and data for controlling the work machine 1. The processor 312 is, for example, a central processing unit (CPU) and executes processes for controlling the work machine 1 according to a program. The first controller 31 controls the travel device 4 or the power transmission device 23, thereby causing the work machine 1 to travel. The first controller 31 controls the control valve 24, thereby causing the work implement 3 to operate.

The second controller 32 includes a memory 321 and a processor 322. The memory 321 includes, for example, a volatile memory such as a RAM and a non-volatile memory such as a ROM. The memory 321 stores programs and data for controlling the work machine 1. The processor 322 is, for example, a central processing unit (CPU) and executes processes for controlling the work machine 1 according to a program. The second controller 32 receives an operation signal from the input device 33. Further, the second controller 32 outputs a signal to the display 36, thereby causing the display 36 to display an image as described later.

The input device 33 receives an operation by an operator and outputs an operation signal according to the operation. The input device 33 outputs an operation signal to the second controller 32. The input device 33 includes an operating element such as an operating lever, a pedal, a switch, or the like for operating the travel device 4 and/or the work implement 3. The input device 33 may include a touch screen. The travel of the work machine 1 such as forward or reverse is controlled according to the operation of the input device 33. Also, the movement of the work implement 3 such as raising or lowering is controlled according to the operation of the input device 33.

The display 36 is, for example, a CRT, an LCD or an OELD. However, the display 36 is not limited to the aforementioned displays and may be another type of display. The display 36 displays an image based on a signal from the second controller 32.

The second controller 32 is configured to wirelessly communicate with the first controller 31 via the communication devices 34 and 35. The second controller 32 transmits the operation signal from the input device 33 to the first controller 31. The first controller 31 controls the travel device 4 and/or the work implement 3 according to the operation signal.

The system 100 includes a position sensor 36 and a light detection and ranging (LiDAR) 37. The position sensor 36 and the LiDAR 37 are mounted on the work machine 1. The position sensor 36 includes a global navigation satellite system (GNSS) receiver 38 and an IMU 39. The GNSS receiver 38 is, for example, a receiver for global positioning system (GPS). The GNSS receiver 38 receives a positioning signal from a satellite and acquires vehicle body position data indicative of position coordinates of the work machine 1 from the positioning signal. The first controller 31 acquires the vehicle body position data from the GNSS receiver 38.

The IMU 39 is an inertial measurement unit. The IMU 39 acquires inclination angle data. The inclination angle data includes an angle with respect to the horizontal in the vehicle front-rear direction (pitch angle) and an angle with respect to the horizontal in the vehicle lateral direction (roll angle). The first controller 31 acquires the inclination angle data from the IMU 39.

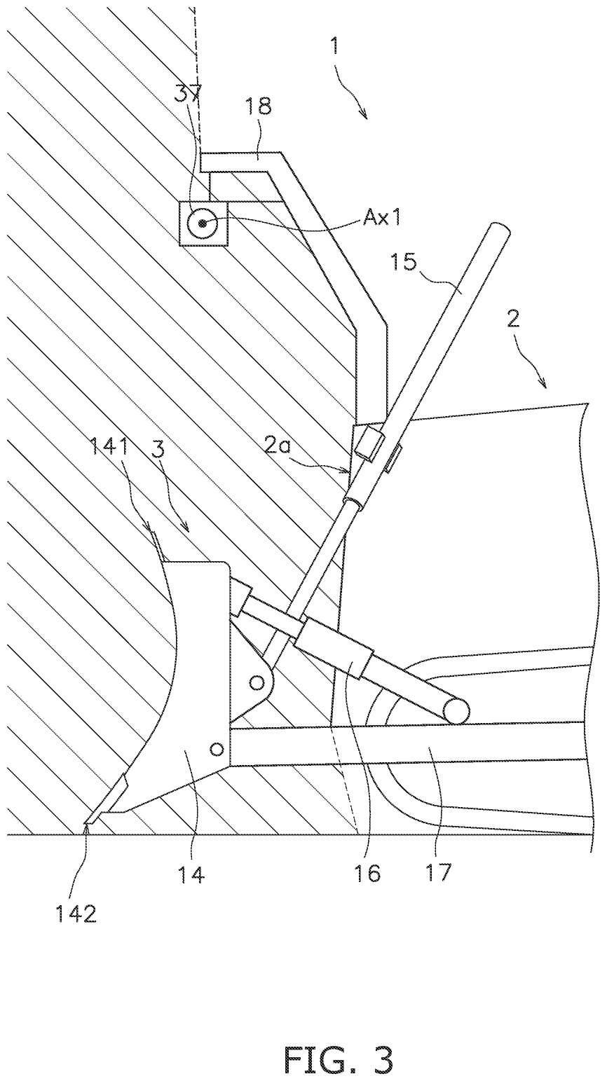

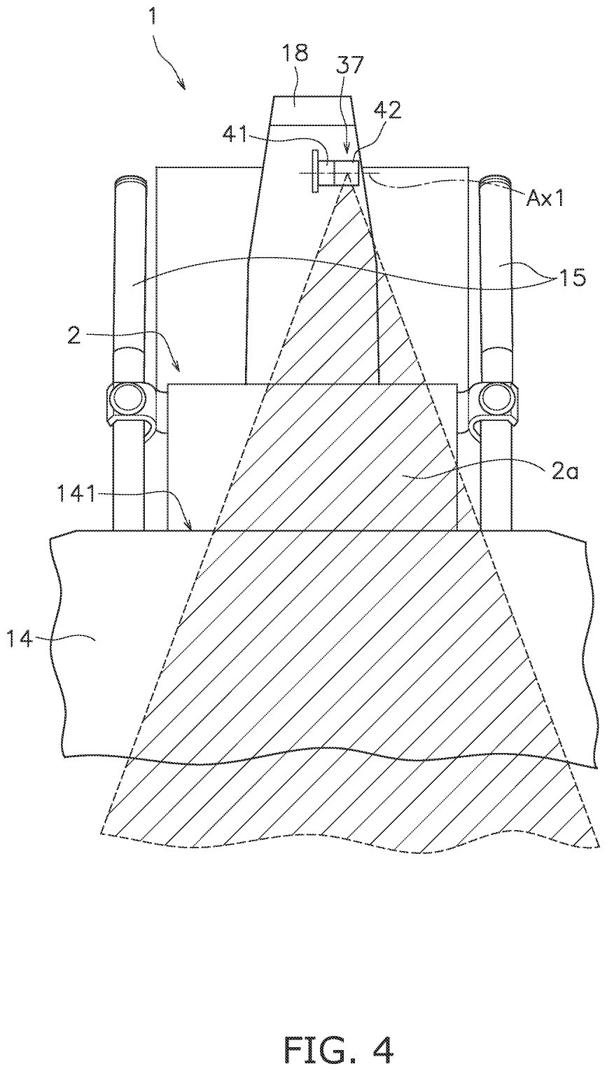

The LiDAR 37 measures three-dimensional shapes of at least a part of the work implement 3 and an object around the work machine 1. FIG. 3 is an enlarged side view of the work machine 1 and the LiDAR 37. FIG. 4 is an enlarged front view of the work machine 1 and the LiDAR 37. As illustrated in FIGS. 3 and 4, the LiDAR 37 is attached to the vehicle body 2 via a support member 18. The support member 18 is attached to the vehicle body 2. The support member 18 extends upward and forward from the vehicle body 2.

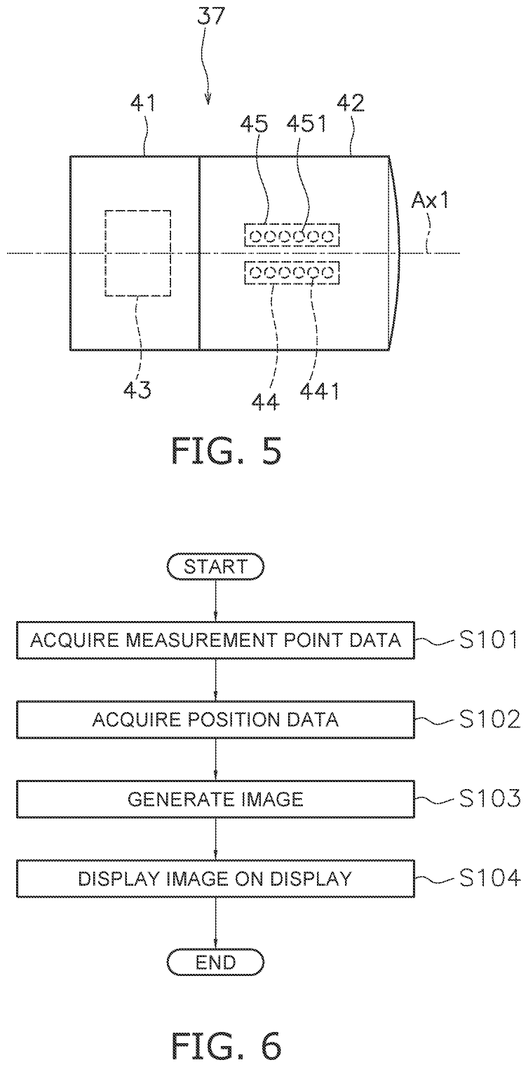

FIG. 5 is a schematic view illustrating a configuration of the LiDAR 37. As illustrated in FIG. 5, the LiDAR 37 includes an attachment portion 41 and a rotating head 42. The attachment portion 41 is attached to the support member 18. The rotating head 42 includes a rotation axis Ax1 and is supported such as to be rotatable around the rotation axis Ax1 with respect to the attachment portion 41. The rotation axis Ax1 is disposed along the horizontal direction. The rotation axis Ax1 is disposed along the left-right direction of the work machine 1.

The LiDAR 37 includes a motor 43, a laser 44, and a photodetector 45. The motor 43 rotates the rotating head 42 around the rotation axis Ax1. The laser 44 is provided on the rotating head 42. The laser 44 includes a plurality of light emitting elements 441 such as a laser diode, for example. The plurality of light emitting elements 441 are aligned in the rotation axis Ax1 direction. In FIG. 5, only one of the plurality of light emitting elements 441 is marked with a reference numeral 441.

The photodetector 45 includes a plurality of light receiving elements 451 such as a photodiode, for example. The LiDAR 37 emits a laser light from the laser 44 and detects its reflected light with the photodetector 45. As a result, the LiDAR 37 measures a distance from the LiDAR 37 to a measurement point on an object to be measured. In FIG. 5, only one of the plurality of light receiving elements 451 is marked with a reference numeral 451.

The LiDAR 37 measures positions of a plurality of measurement points at a predetermined cycle while rotating the laser 44 around the rotation axis Ax1. Therefore, the LiDAR 37 measures distances to the measurement points at a certain rotation angle. The LiDAR 37 outputs measurement point data. The measurement point data includes information on which element has been used for measuring each measurement point, at which rotation angle each measurement point has been measured, and positional relationships between each measurement point and each element.

As illustrated in FIG. 3, the LiDAR 37 is disposed more toward the blade 14 than toward the vehicle body 2 in the front-rear direction of the work machine 1. The LiDAR 37 is disposed in front of a front surface 2a of the vehicle body 2. The LiDAR 37 is able to perform measurement by rotating the rotating head 42 by 360 degrees around the rotation axis Ax1 extending in the left-right direction of the work machine 1. Therefore, the vertical field of view of the LiDAR 37 is 360 degrees. As illustrated in FIGS. 3 and 4, the horizontal field of view of the LiDAR 37 is smaller than the vertical field of view of the LiDAR 37.

In FIGS. 3 and 4, a measurement range of the LiDAR 37 is indicated by hatching. As illustrated in FIGS. 3 and 4, the measurement range of the LiDAR 37 includes at least a part of the blade 14 and an object in front of the blade 14. Further, the measurement range of the LiDAR 37 includes at least a part of the front surface 2a of the vehicle body 2. Specifically, the measurement range of the LiDAR 37 includes an upper end 141 of the blade 14. The measurement range of the LiDAR 37 includes a lower end 142 of the blade 14. The LiDAR 37 measures distances to the plurality of measurement points on the blade 14. Further, the LiDAR 37 measures distances to the plurality of measurement points on an object in front of the blade 14.

In the present embodiment, based on the positions of the measurement points measured by the LiDAR 37, images indicative of the blade 14 and the object in front of the blade 14 are generated and displayed on the display 36. Hereinafter, processes executed by the first controller 31 and the second controller 32 in order to generate an image will be described. FIG. 6 is a flowchart illustrating the processes executed by the first controller 31 and the second controller 32.

As illustrated in FIG. 6, in step S101, the first controller 31 acquires measurement point data. Here, the first controller 31 measures distances to the plurality of measurement points with the LiDAR 37 while rotating the rotating head 42 around the rotation axis Ax1. As a result, the first controller 31 acquires the measurement point data. The measurement point data includes the distances to the plurality of measurement points included on the blade 14 and a topography in front of the blade 14.

In step S102, the second controller 32 acquires position data. Here, the second controller 32 receives the measurement point data from the first controller 31. The second controller 32 includes information indicative of a positional relationship between the LiDAR 37 and the work machine 1. The second controller 32 calculates and acquires the position data indicative of the blade 14 and the topography in front of the blade 14 from the measurement point data. Instead of the second controller 32, the first controller 31 may calculate and acquire the position data from the measurement point data. In that case, the second controller 32 may receive the position data from the first controller 31.

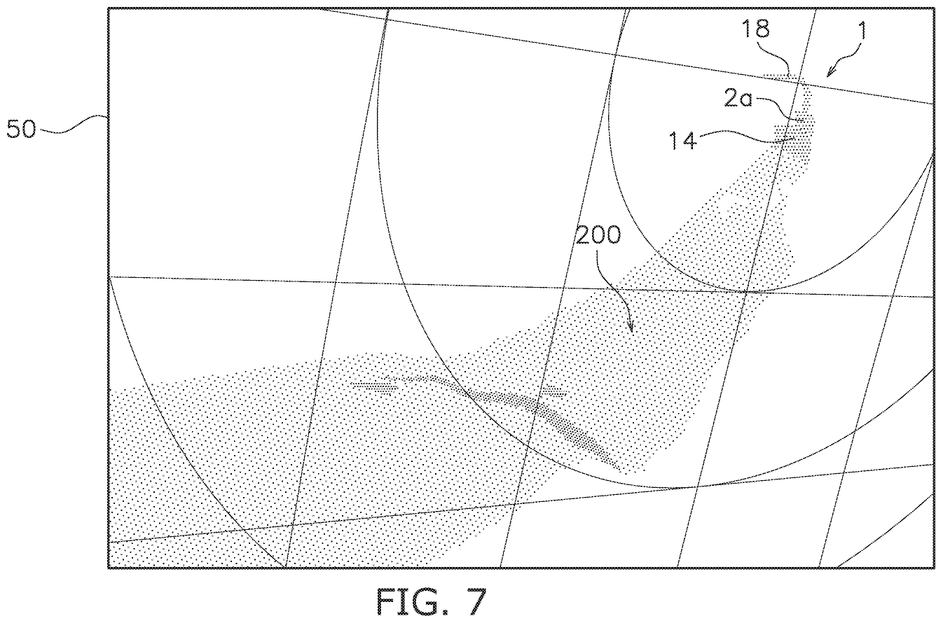

In step S103, the second controller 32 generates an image 50 indicative of the blade 14 and the object in front of the blade 14 based on the position data. FIG. 7 is a view illustrating an example of the image 50. As illustrated in FIG. 7, the image 50 is represented by a point cloud indicative of the plurality of measurement points. The image 50 includes the blade 14 and a topography 200 in front of the blade 14. Further, the image 50 includes the front surface 2a of the vehicle body 2 and the support member 18. In FIG. 7, the image 50 is an image in which the work machine 1 and its surroundings are viewed from the left front viewpoint of the work machine 1. However, the first controller 31 or the second controller 32 is able to switch a viewpoint of the image 50 to another direction.

In step S104, the second controller 32 outputs a signal indicative of the image 50 to the display 36. As a result, the display 36 displays the image 50. The image 50 is updated in real time and displayed as a moving image. Therefore, when the work machine 1 is traveling or operating, the image 50 is changed and displayed according to a change in the surroundings of the work machine 1.

In the system 100 according to the present embodiment described above, the position data is acquired from the distances to the plurality of measurement points measured by the LiDAR 37. Then, based on the position data, the image 50 is generated and displayed on the display 36. The image 50 indicates the positions of at least the part of the work implement 3 and the object around the work machine 1. Therefore, a user is able to easily and accurately recognize the positional relationship between the work machine 1 and the object around the work machine 1 owing to the image 50.

Although the embodiment of the present disclosure have been described above, the present invention is not limited to the above embodiment and various modifications may be made within the scope of the invention.

The work machine 1 is not limited to a bulldozer and may be another vehicle such as a wheel loader, a motor grader, a hydraulic excavator, or the like. The work machine 1 may be a vehicle driven by an electric motor. The operating cabin 12 may be omitted from the work machine 1.

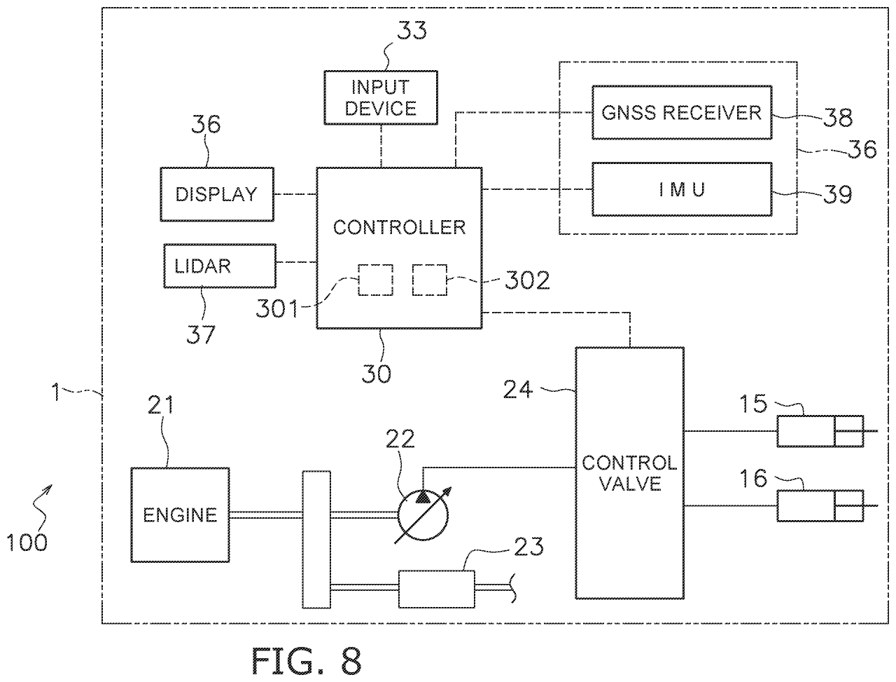

The work machine 1 may be operated in the operating cabin instead of being remotely operated. FIG. 8 is a diagram of a configuration of the work machine 1 according to a modified example. As illustrated in FIG. 8, the work machine 1 may include a controller 30 mounted on the work machine 1. The controller 30 may include a memory 301 and a processor 302. The controller 30 has the same configuration as the first controller 31 and the second controller 32 described above and therefore detailed description thereof will be omitted. The controller 30 may execute the abovementioned processes from steps S101 to S104. In this case, the input device 33 may be disposed in the operating cabin.

The first controller 31 is not limited to one unit and may be divided into a plurality of controllers. The second controller 32 is not limited to one unit and may be divided into a plurality of controllers. The controller 30 is not limited to one unit and may be divided into a plurality of controllers.

The configuration and/or disposition of the LiDAR 37 is not limited to the position of the above embodiment and may be changed. For example, the rotation axis Ax1 of the LiDAR 37 may be disposed along the vertical direction. Alternatively, the LiDAR 37 may be non-rotatable. The direction measured by the LiDAR 37 is not limited to the front diction of the work machine 1 and may be a rear direction, a lateral direction, or another direction of the work machine 1. The object around the work machine 1 measured by the LiDAR 37 is not limited to the topography 200 and may include another work machine, a building, a person, or the like.

In the present disclosure, the positional relationship between the work machine and the object around the work machine can be easily and accurately recognized owing to the image.

1. A system comprising:
a work machine including a work implement;
a LiDAR attached to the work machine, the LiDAR including a laser and a photodetector, and the LiDAR being configured to measure
a distance to at least a part of the work implement and
a distance to an object around the work machine;
a processor configured to
acquire position data indicative of a position of at least the part of the work implement and a position of the object around the work machine from the distances measured by the LiDAR and
generate an image indicative of the position of at least the part of the work implement and the position of the object around the work machine based on the position data; and
a display configured to display the image in response to a signal from the processor.

2. The system according to claim 1, wherein
the work machine further includes a vehicle body configured to support the work implement, and
the LiDAR is disposed more toward the work implement than toward the vehicle body.

3. The system according to claim 1, wherein
the LiDAR includes a rotation axis and the LiDAR is configured to rotate around the rotation axis.

4. The system according to claim 3, wherein
the rotation axis is disposed along a left-right direction of the work machine.

5. The system according to claim 1, wherein
the image is represented by a point cloud indicative of a plurality of measurement points on the work implement and a plurality of measurement points on the object around the work machine.

6. The system according to claim 1, wherein
the work implement includes a blade, and
a measurement range of the LiDAR includes an upper end of the blade.

7. The system according to claim 1, wherein
the work implement includes a blade, and
a measurement range of the LiDAR includes at least a part of the blade and an object in front of the blade.

8. The system according to claim 1, wherein
the work implement includes a blade,
the work machine further includes a vehicle body configured to support the blade, and
a measurement range of the LiDAR includes at least a part of a front surface of the vehicle body and at least a part of the blade.

9. A method executed by a processor in order to display a topography around a work machine including a work implement and a position of the work implement on a display, the method comprising:
measuring a distance to at least a part of the work implement and a distance to an object around the work machine by a LiDAR;
acquiring position data indicative of a position of at least the part of the work implement and a position of the object around the work machine from the distances measured by the LiDAR;
generating an image indicative of the position of at least the part of the work implement and the position of the object around the work machine based on the position data; and
displaying the image on the display.

10. The method according to claim 9,
the work machine further includes a vehicle body configured to support the work implement, and
the LiDAR is disposed more toward the work implement than toward the vehicle body.

11. The method according to claim 9, wherein
the measuring the distance to at least the part of the work implement and the distance to the object around the work machine occurs while rotating the LiDAR.

12. The method according to claim 9, wherein
the measuring the distance to at least the part of the work implement and the distance to the object around the work machine occurs while rotating the LiDAR around a rotation axis extending along a left-right direction of the work machine.

13. The method according to claim 9, wherein
the image is represented by a point cloud indicative of a plurality of measurement points on the work implement and a plurality of measurement points on the object around the work machine.

14. The method according to claim 9, wherein
the work implement includes a blade, and
a measurement range of the LiDAR includes an upper end of the blade.

15. The method according to claim 9, wherein
the work implement includes a blade, and
a measurement range of the LiDAR includes at least a part of the blade and an object in front of the blade.

16. The method according to claim 9, wherein
the work implement includes a blade,
the work machine further includes a vehicle body configured to support the blade, and
a measurement range of the LiDAR includes at least a part of a front surface of the vehicle body and at least a part of the blade.

17. A system comprising:
a processor configured to
acquire a distance to at least a part of the work implement and a distance to an object around the work machine measured by a LiDAR,
acquire position data indicative of a position of at least the part of the work implement and a position of the object around the work machine from the distances measured by the LiDAR, and
generate an image indicative of the position of at least the part of the work implement and the position of the object around the work machine based on the position data; and
a display configured to display the image in response to a signal from the processor.
